(19) United States
(12) Patent Application Publication
(10) Pub. No.: US 2008/0096171 A1
(43) Pub. Date: Apr. 24, 2008

(54) System and method for improving reading skills

(76) Inventor: Deborah Movahhedi, Annandale, VA (US)

Correspondence Address: STANLEY MARCUS & ASSOCIATES, PLLC, Suite 100, 1455 Pennsylvania Ave NW, Washington, DC, 20004-1001, US

(21) Appl. No.: 11/783,571

(22) Filed: Apr. 10, 2007

Related U.S. Application Data
(60) Provisional application No. 60/851,301, filed on Oct. 13, 2006.

(51) Int. Cl. G09B 17/00

(52) U.S. Cl. 434/178

(57) ABSTRACT

A system and method for improving reading through use of games is disclosed. The pairing of game playing with teaching as provided by the present invention heightens a student's level of awareness, generates enthusiasm for learning, increases mental alertness, wakes up a student's intellect, and trains that intelligence in a way that supports proficient reading.

### RELATED APPLICATION

This application claims priority to U.S. Provisional Application Ser. No. 60/851,301 filed Oct. 13, 2006, which is hereby incorporated by reference.

### FIELD OF INVENTION

The present invention generally relates to a system and method for improving intellectual processes that results in improved reading skills in students of all ages.

### BACKGROUND OF INVENTION

There is a growing problem of illiteracy and poor reading proficiency among children and the adult population in this country. One study reports that between 22% and 67% of fourth grade elementary students residing in any given state, including the District of Columbia, have been tested as reading below the basic competency level.

The lack of reading proficiency may be attributable to a combination of factors occurring during a child's early school years. During this critical period for reading training, if a child suffers from one or a combination of factors, there is a good possibility that the opportunity to build the necessary foundation required for reading proficiency is severely weakened.

These factors may involve, for example, a child switching schools during a critical stage in the learning process; absence from school; illness; undetected visual or hearing problems; low-grade physical distress caused by undetected allergies; malnutrition, which does not support learning; sleep deprivation during the learning process; distractions, which may be caused by emotional familial tensions such as parental separation, divorce, illness, death, abuse, etc.; teacher personality conflict(s); discomfort with the school environment or teachers; slow rate of learning; teaching style incompatible with the child's learning style; use of prescription or other medication; inability to focus due to learning adjustment difficulties, which may be based on social inexperience or emotional immaturity; parents or caretakers who are not proficient readers; non-native English speaking guardians; and/or lack of intellectual stimulation at home.

A child's lack of reading proficiency may also be attributable to a child's shy and retiring disposition, daydreaming, or just lack of motivation to exert the required level of effort to learn to read better.

A problem with one or more prior art reading methodologies is the heavy emphasis on phonics to the exclusionary use of other learning techniques. Phonics is best described as the concept that all alphabets (individually or grouped) have a corresponding mouth, tongue and lip position, which will produce certain sound patterns when formed to speak words.

Phonics is primarily effective for learning one-syllable words composed of four or less letters. However, it tends to be less useful for words of more than one syllable, or words with blends, words with two vowels together, or even words with silent letters. Moreover, when too much emphasis is placed on learning to read by sounding out words phonetically only, the reading process is stymied.

The reason why phonics and other prior art reading methodologies prove not useful in improving reading competency over the long run is because the English language is really a blend of the sound patterns and spellings from several languages, such as British English, German, French, Latin, Spanish and Italian, just to name a few. There simply are too many exceptions to the rules of pronunciation and spelling of written Americanized English.

For example, a phonetic sounding out of a word like “scissors” will not enable a student to discern that: (1) the first “s” takes on the traditional “es” sound; (2) that the second two “s” take on the “zee” sound; and (3) that the “c” is silent rather than taking on the “k” sound as the “sc” in “scoop”. Any phonetically trained reading student who attempts to sound-out the word “scissors” will be stumped.

A second problem with phonics and other prior art reading methodologies is similarly fundamental; they tend to be less useful when a student does not know where a word breaks for syllabification, or has poor phonemic awareness. What happens, as a result, is that the student who is unfamiliar with a multi-syllable word, especially one where the consonant and vowel sounds have irregular pronunciations or sounds, spends so much time trying to decode the multi-syllable word that the student forgets the portion of the sentence already read. In this instance, where the student has poorly functioning short-term memory to begin with, reading comprehension is severely compromised.

### SUMMARY OF INVENTION

The present invention satisfies, to a great extent, the foregoing and other needs not currently satisfied by existing teaching/reading techniques. This result is achieved, in an exemplary embodiment, by a system and method for improving reading skills by introducing game playing into the learning session. Employing the gaming process as a learning vehicle for reading stimulates a student's intellectual energy, interest and excitement in learning. What is more, it significantly improves each of the four reading skills—critical thinking, memory and recall, visual acuity and discrimination, and data analysis/strategic planning—with unexpected reading improvement results within a very short period of time (30 days).

With these and other features and advantages of the invention that may become hereinafter apparent, the nature of the invention may be more clearly understood by reference to the following detailed description of the invention, the appended claims and to the several drawings attached herein.

### BRIEF DESCRIPTION OF THE DRAWINGS

FIGS. 1-2 show a flow chart of the decision logic describing the teaching process for improving reading skills in accordance with a preferred embodiment of the present invention.

FIG. 3 illustrates an exemplary test and practice Exercise 1 listed in FIG. 4.

FIG. 4 is an exemplary list of test and/or practice reading exercises formulated by the inventor by skill category, in accordance with an embodiment of the present invention.

FIG. 5 illustrates an exemplary test and practice Exercise 11 listed in FIG. 4.

FIG. 6 is a flow diagram showing exemplary exercises comprising a reading lesson plan by skill category in accordance with an embodiment of the present invention.

FIG. 7 is a flow diagram showing exemplary exercises comprising an alternate reading lesson plan by skill category.

FIG. 8 is a flow diagram showing exemplary exercises comprising an alternate reading lesson plan by skill category.

FIG. 9 is a flow diagram showing exemplary exercises comprising an alternate reading lesson plan by skill category.

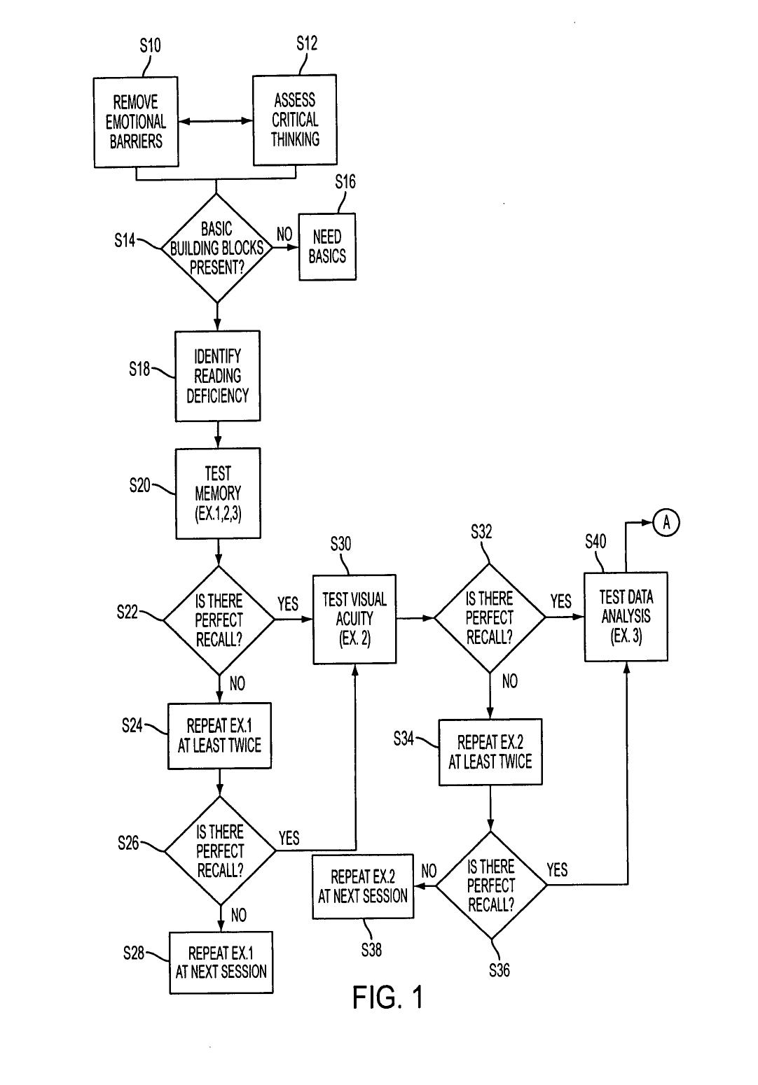

### DETAILED DESCRIPTION OF PREFERRED EMBODIMENTS

As a practical matter, reading consists of four steps: (1) learning the symbols or alphabets; (2) learning the sounds that the symbols or alphabets represent; (3) learning the pronunciation and meanings of words that are represented by certain symbols grouped together; and (4) memorizing the words and meanings in order to recall this information on sight.

Most students can perform number one easily. They perform number two and four with varying degrees of difficulty. However, the major problem tends to be with number three.

There are four primary reading support skills that are important to the reading process. The first one is critical thinking; that is, learning how to concentrate/focus on components of data in order to learn how to organize data in such a way as to be able to use the data to gain an understanding of the data's implication.

The second skill is visual acuity or discrimination; that is, the ability to discriminate detail visually. Proficiency in this skill trains an individual to understand what one is seeing and to differentiate between items.

The third skill is memorization and recall, which refers to the storage, retention and recall of information previously learned or experienced. Short-term and long-term memorization and recall abilities are important skills for comprehending oral and written ideas. Reading comprehension generally requires use of short-term memory skills in order to remember information recently read. Long-term memory skills are employed for storing new vocabulary, for example, whether it was learned aurally or in writing. Long-term memory storage is important for proficient knowledge building, which occurs cumulatively.

The fourth and final primary skill is data analysis/strategic planning; that is, assessing and analyzing words and sentences in a way that maximizes comprehension.

Using the present invention, each of these four reading support skills are assessed and improved during game playing to where students recognize familiar words, comprehend definitions, and memorize and recall information conveyed through the text students read. By consequence, each of the four steps of reading is significantly improved, including the traditional problem reading areas of steps two, three and four mentioned above.

What is more, the present invention not only generates improvement in reading ability in a relatively short period of time (approximately 30 to 60 days) but it improves the reading achievement level of the student. In other words, unlike other prior art method and materials, the methods and materials of the present invention strengthen a student's skill level beyond basic reading to the proficient or advanced level of reading.

This unexpected result is largely attributable to the fact that the method and materials of the present invention accustom students to manipulating all aspects of written language early through the immediate introduction of multi-syllabic words, creation of a written alphabet, doing word jumbles, writing essays, poetry reading and writing, etc. The present invention demystifies the English language and resolves students' confusion by walking the student through the process step by step.

In accordance with a preferred embodiment of the present invention, the first step seeks to lower or remove any emotional barriers to learning (S10). In the inventor's experience, a student's past failed efforts at learning to read oftentimes results in emotional trauma and the avoidance of any attempt to be taught how to read.

One tool that has proved effective in reducing or eradicating emotional barriers to learning is the introduction of game playing because it engages a student emotionally while having fun. For example, a student who is depressed, is repressing resentment or is otherwise generally unhappy, is sometimes unable to generate the intellectual energy required for proper learning. The institution of game playing into the learning session creates an emotional catharsis designed to unblock the student's emotional energy, either temporarily or permanently.

Employing games as an aid for teaching and learning proper reading and spelling, as provided by the present invention, is so structured because the games require attention to detail, the application of visual analysis skills, and the application of critical planning and intellectual organization skills. The simplicity of game play and the luck factor allow beginning players to engage in play with players of all ages without intimidation. Game structures are designed for basic moves, play is relatively rapid, and the game stimulates intellectual energy.

Employing the gaming process as a learning vehicle for reading stimulates a student's intellectual energy and interest in learning generally by first generating the thrill of accepting a challenge, which is a key attribute of playing games. The emotional drive to conquer or win and the excitement or positive emotional energy stimulated during game playing, are transferable to the learning process. Equally important, the student's interest in playing the selected game is easily transferable to the learning process as well.

Accordingly, the pairing of game playing with teaching as provided by the present invention heightens a student's level of awareness, generates enthusiasm for learning, increases mental alertness, wakes up the latent natural abilities of each student's intellect, and trains that intelligence in a way that supports competent reading.

It provides two important benefits; first, the student's willing participation in the reading lesson; and second, better development of visual acuity and critical thinking skills, sharper concentration, and improved memorization skills, all of which improve reading abilities. The skills developed by employing the present invention enable students to predict, plan, calculate, question, manipulate and use their intelligence as a tool to gain information from most textual information read.

To gain the highest level of motivation from younger students, use of a reward system to provide encouragement and positive reinforcement proves effective. One reward may include offering small, store-bought prizes for good effort. Another reward example may include offering a weekly allowance that is tied to the student's level of effort. For instance, a parent may set a regular allotment (i.e. a dime or quarter) for each new 3-5 syllable word a student learns. Alternatively, a parent may set a minimum payment of $1 to $2 for each reading session successfully completed.

In one embodiment of the invention, one game that may be employed at Step S10 is UNO®. This game is selected because it tends to generate a higher level of transferable interest and excitement in students young and old, and employs critical thinking, organizational and strategic planning skills.

By way of brief official rules of the game, a custom deck consists of cards of four suits (colors): red, green, blue and yellow. The ranks in each such are zero to 9. There are three “honor” cards in each suit labeled “skip”, “draw 2” and “reverse”; there are two copies of each honor card. There are two special black cards labeled “wild” and “wild draw 4”; there are four copies of each black card. There are two copies of each regular card, except for the zeros, which only have one per suit. This produces a total of 108 cards.

To start the game, seven cards are dealt each player, and the top card of the stock is exposed to start the discard pile. At each turn, a player may play a card from their hand that matches the suit or rank of the top exposed card, or play a “wild” or “wild draw 4” card. The objective of the game is to be the first player to discard all cards. The objective is made challenging because players may miss turns to discard a card, receive additional turns to discard cards, or a player may be required to pick an unlimited number of additional cards from the stock or draw pile.

Once instructions have been provided to the student and game playing begins, the student's level of sophistication and understanding of the game (i.e. critical thinking) is also preferably assessed (S12). Is the student having difficulty following detailed instructions? Does the student use the “special cards” appropriately? If not, suggest times when it might be strategic to use specific cards. If the student's strategic planning skills need no reinforcement, then one game of UNO® (15-20 minutes) is played as a warm-up to the reading lesson.

At this juncture, it is appropriate to confirm whether the student has the basic building blocks of reading (S14). Four suggested areas of development assessment includes: (1) confirming the student's knowledge of numbers by having the student recite from 1 to 20; (2) confirming the student's knowledge of the alphabet by having the student repeat the alphabet from A to Z; (3) confirming the student's knowledge of alphabet sounds by having the student pronounce the basic sounds of the alphabet; and (4) confirming the student's knowledge of consonants and vowels.

If the student is not successful in one or more of the above three areas (S16), the student must learn the basics before moving forward. If the student responds successfully to each of the above areas, the next step is to assess the level of development of the four skills necessary to support reading ability (S18).

This is accomplished by having the student read at least one page of age-/grade-level appropriate text out loud. Preferably, the student's reading is taped in order to determine, with an opportunity for later review, the student's reading problem areas. Moreover, the student's reading performance may be recorded periodically so that the recordings may be compared over time to further assess and verify reading improvement.

During the assessment stage in Step 18, one or more of a number of reading difficulties may be observed.

One reading deficiency may be manifested in the form of a choppy, staccato manner of reading where the student reads words correctly but spends so much time deciphering most words that there are long pauses between words. Another reading difficulty may be manifested when a student reads relatively well but substitutes different words in place of text on the page read, or does not read the correct beginning or ending of a word. Yet a third difficulty may be manifested when the student does not stumble over most one syllable words but can only sound out the first syllable of a multi-syllable word.

Each reading deficiency should be appropriately categorized into one (or more) of the four primary reading skills. For example, in the first noted deficiency above, this may fall into the area of data analysis and/or memory recall. One solution is to tape the instructor reading a sample passage or, alternatively, reading the same passage that the student previously read, which was preferably taped. Replay both taped readings (student passage and instructor passage) so that the student hears the difference between the two passages. This type of reading style impacts comprehension particularly if the student's memory skill is also poor.

In the second noted deficiency above, this may fall under the area of visual acuity and distinction. One solution may require having the student's vision corrected. If vision (including corrected vision) is adequate, another solution is for the student to practice to develop/improve visual abilities using the combination of exemplary exercises compiled/provided by the inventor, such as Exercise 7 dealing with matching patterns of beads.

In the third noted deficiency above, this may be categorized under data analysis/strategic planning because the student may be attempting to apply the rules of phonetic deciphering to words where the rules of phonics cannot be applied. This often happens in instances where words have irregular phonetic spelling, or where letters have more than one pronunciation, and/or where there is more than one possible place to break a syllable. One solution may include using Exercise 11 designed to introduce the student to the guide to using a dictionary, usually located at the beginning of each dictionary. A dictionary's guide introduces the student to word syllabification and the logic behind word pronunciation.

It is important to emphasize that instructors using the present invention be on the lookout for a deficiency that may not fall within the four primary skill areas. A good example is a deficiency manifested wherein a student reads in a sluggish manner. The solution may be as simple as checking the student's (poor) posture, and advising the student about proper posture. This may also include showing the student how to breathe deeply and take inhalations every few minutes and/or every five to six words, and at commas to obviate a shallow breathing habit. Poor posture may be a contributing cause of diminished lung expansion which prevents proper blood flow and oxygen to the brain, which in turn may diminish the student's ability to experience insight and understanding.

Other possible causes of sluggish reading may include sleep deprivation, poor nutrition or lack of exercise.

Once each reading deficiency has been identified, the next step is to test the student's memory capabilities (S20). Memory testing is performed earlier rather than later in the assessment process because studies have found that memory and comprehension are linked together. Strengthening memory almost always leads to improved reading comprehension.

In a preferred embodiment, memory testing is best accomplished by using the following sets of exercises labeled Exercises 1, 2 and 3.

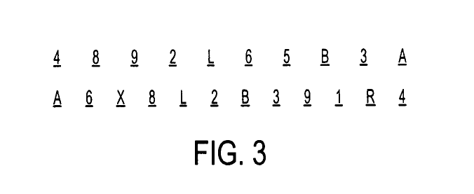

Referring now to FIG. 3, there is shown an exemplary test and practice Exercise 1 comprising a mixed set of numbers and alphabets used to train a student to distinguish between a variety of characters; in this case, they are consonants, vowels and numbers. This test requires the student to recognize each individual character and its position in the data set.

The goal of Exercise 1 is to strengthen the student's memory, to improve the student's ability to concentrate, and to improve the student's understanding of positional recognition as contrasted within a group of characters. An understanding of character or symbol position is required to correctly spell words. This understanding is also required for word recognition and recall.

The exercise involves the student analyzing the 10 or 12-digit set of alphabets and numbers. Introduce the student to the memory technique of mnemonics. Mnemonics is any system the student may create to help recognize a word after it has been introduced and removed from the student's vision. Once the technique is explained to the student, have the student create one or more personal mnemonics to assist with memorizing the above set of mixed alphabets and numbers.

To assist the student in creating a mnemonic system, encourage the student to determine if there are any patterns by analyzing the information presented in the exercise. The following questions may be posed: How many numbers are there? How many letters are there? Do any numbers or letters repeat? How many times does any letter or number repeat? Does the series begin with a letter or number? Does the series end with a letter or a number? How many odd numbers are there? How many even numbers are there? Are there more letters from the beginning or end of the alphabet?

Ask the student how much time will be needed to memorize the data set given, remove the data set and allot the designated time. If the student is not successful in reciting/writing the data set as presented, repeat the exercise.

Spend approximately 15 to 20 minutes on this exercise.

Once the memory test(s) is/are administered in Step 20, the next decisional inquiry is whether there is perfect recall (S22). If not, Exercise 1 is repeated at least twice (S24). If perfect recall is still not achieved (S26), then Exercise 1 is repeated at a subsequent (another) reading session (S28).

However, if perfect recall is achieved as at Steps S22 and S26, then visual acuity is tested (S30) preferably through the administering of Exercise 2.

Exercise 2 involves placing twelve (12) small objects in a row in front of the student. For ease of handling, the objects should be approximately one to two inches in size. For example, preferable objects include miniature toys, small clay animals, a perfume sample, a pin, small magnetic objects, a small key, a ring, a button, a paper clip, a screw, a battery, a rubber band, travel-size toothpaste tube, and the like. In addition, the small objects should be preferably eye-catching or easy to remember. The student and instructor should identify a common name for each object to ensure that the student knows what the object is.

This memory recall exercise uses a mixed set of objects to hone a student's ability to distinguish between discrete items, whether those items are small objects or a variety of alphabet characters, such as consonants and vowels found in words. This exercise also serves as a test and as practical reinforcement as it requires the student to make a close examination of each item and its position in the object set.

The goal of Exercise 2 is to strengthen the student's memory, to improve the student's ability to concentrate, and to improve the student's understanding of positional recognition as contrasted within a group of objects. The process is designed to be equivalent to perceiving the alphabets in a word as separate and distinct characters though the objects used are larger scale than typical alphabets used in writing.

This exercise involves the student analyzing the object set and using mnemonics, if necessary, to assist with memorizing the group of objects and its position in the row.

Ask the student how much time will be needed to memorize the object set given, cover the object set and allot the designated time. If the student is not successful the first time (S32), repeat the exercise (S34) until the object set (in its original position) can be written without error, preferably at least twice. Spend approximately 15 to 20 minutes on this exercise. If the student does not achieve perfect recall (S36), repeat this exercise in a subsequent (second) reading session (S38).

However, if there is perfect recall of Exercise 2, then data analysis/strategic planning is tested (S40) preferably through the administering of Exercise 3.

Exercise 3 is a spelling and word recognition exercise. It is designed to demystify multi-syllabic words and provide the student with a word attack plan (i.e. data analysis).

The exercise involves selecting a word, preferably 5 to 6 syllables in length, for the student to learn to spell, such as encyclopedia. In a preferred embodiment, each student is taught how to analyze the word in accordance with the following procedures.

First, have the student count the total number of letters in the word. In our example, encyclopedia has 12 letters.

Second, have the student count the number of consonants and vowels in the word. In our example, encyclopedia has six consonants and six vowels.

Third, have the student divide the word into syllables using a dictionary if needed. In our example, encyclopedia has six syllables.

Fourth, ask the student how many syllables there are in the selected word.

Fifth, have the student create a set of mnemonics to assist with memorizing the word by asking the following or similar questions: What are the positions of the consonants and vowels? Are there any smaller words within the larger word? Can the word be associated with a similar known word or an experience?

Sixth, ask the student how much time will be needed to memorize the selected word, remove the word and allot the designated time for memorization.

Seventh, have the student attempt to spell the word correctly out loud and in writing.

The next decisional inquiry is whether the student correctly reads the selected word in Exercise 3 (S42). If not (S44), repeat the syllabification procedure, preferably no more than twice, before moving on to the next exercise in Step 46.

Spend approximately 15 to 20 minutes on Exercise 3 before moving on. Additionally, this exercise may be repeated any time a student is having difficulty learning to spell a new word.

If the student successfully completes Exercise 3, by answering decisional inquiry (S42) in the affirmative, the next step is to test visual acuity and critical thinking (S46) preferably through the administering of Exercise 6.

Exercise 6 involves putting together a jigsaw picture puzzle without seeing what the picture looks like before assembly. The student is provided no information about the nature of the picture that makes up the puzzle; in this regard, this exercise is viewed as equivalent to an unknown word of any size. Therefore, this exercise is used so that the student gains experience manipulating unknown material in a piece-by-piece fashion in order to discern the whole.

At least two qualities of the jigsaw puzzle picture prove useful in teaching or improving a student's ability to read: (1) the shapes of the puzzle pieces, whether straight edge or the irregular shapes of the intrusions and protrusions; and (2) the differing colors of the individual puzzle pieces. Through this exercise, a student is trained to visually compare and analyze the shapes and colors against each other in order to join together matching pieces. Exercise 6 therefore serves to develop and refine the student's visual acuity.

The idea here is that the instructor observes the student to determine, for example, how the student organizes the task of assembling puzzle pieces together, how the student attempts to match pieces together, and how long the process takes.

For students who demonstrate frustration or inexperience putting puzzle pieces together, or demonstrate an inability to complete the picture within a specific time frame due to use of a less efficient method, instruction is provided regarding how to organize the task of assembly. In a preferred embodiment, a student is provided with the following visual attack plan:

First, turn all the puzzle pieces face up.

Second, select four corner pieces of the puzzle. The student may be shown the difference between the four corner pieces and the other two groups of puzzle pieces; namely, the pieces with one straight edge, and pieces with protrusions and intrusions.

Third, place the puzzle pieces with one straight edge into separate groups based on similar color.

Fourth, complete the border or four sides of the puzzle by connecting the corner pieces and the puzzle pieces with one straight edge.

Fifth, place all remaining puzzle pieces into separate groups according to similar colors.

Sixth, complete the remaining parts of the puzzle by comparing the colors and shapes of puzzle pieces already connected in the puzzle with the color and shapes of puzzle pieces still remaining to be placed in the puzzle.

If the student is at least seven or eight years old, he or she is provided with a 100-piece puzzle, which is already broken apart, to assemble. Students under age seven may be provided with 25 to 50 piece puzzles to complete.

The next step in the process is the decisional inquiry whether the student exhibited appropriate organizational skills required by Exercise 6 for successful completion (S48). If not, as earlier described, the student is instructed with a visual attack plan (S50). If such skills were displayed, the student is encouraged to practice their reading skills (S52) preferably through administering Exercise 15.

Exercise 15 involves the student reading from an age-level or grade-level appropriate book on a topic of particular interest to him/her. The reading session should last from 15 to 30 minutes. Preferably, each student is asked to scan the desired reading material for unknown words before attempting to read the book. After making a list of each unknown word, the student is asked to enunciate, define and speak each unknown word out loud at least twice, with corrections provided by an instructor as needed. This facilitates reading with minimal confusion and hesitation.

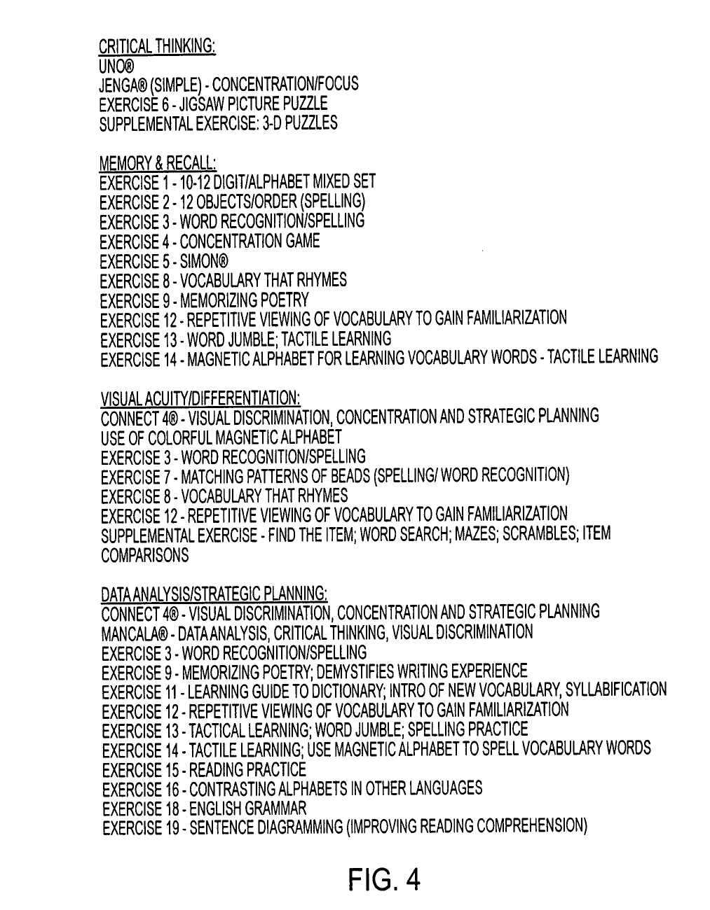

If reading proficiency is determined to be improved (S54), provide the student with homework exercise(s) for the next session (S56), preferably selected from the exemplary list of exercises formulated by the inventor as depicted in FIG. 4. These sessions are recommended to occur at least once weekly for approximately one and one-half to two hours per session. As previously indicated, reward the student with incentives, prizes or study allowance for good effort/results.

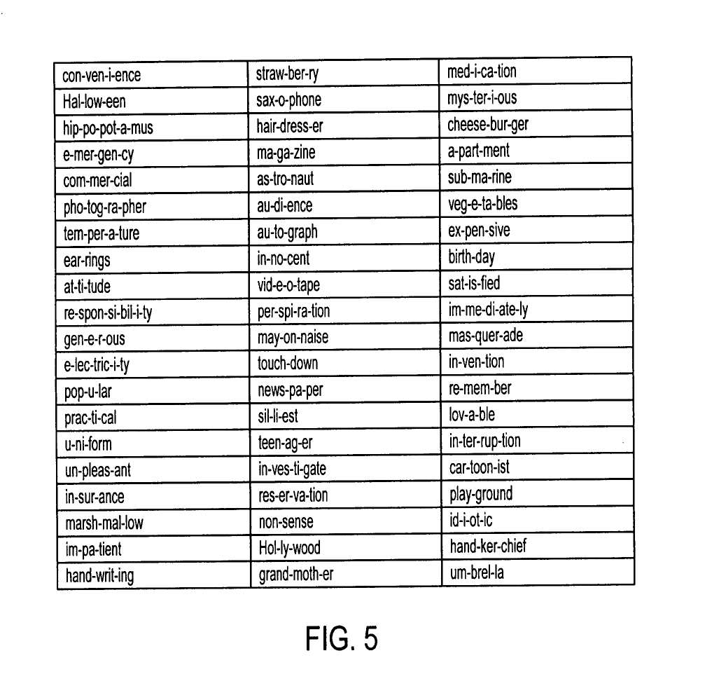

If reading proficiency was not improved, provide the student with homework exercises for the next session (S58). One exemplary homework assignment that may be assigned to the student for the next session (Session #2) is Exercise 11 (explained later); more specifically, to review and study vocabulary from the exemplary list of vocabulary provided in FIG. 5.

Regarding FIG. 4, there is shown an exemplary list of the types of exercises provided by each skills category that was formulated by the inventor. This list is not exhaustive. Notably, there are gradations of complexity between the game exercises where different skills are used to play the games. This is so designed to accommodate age, gender and interest, which varies with each student.

For example, as between UNO®, Jenga®, Connect 4® and Mancala®, UNO® requires use of more variety of reading skills than the other three. Jenga® and Connect 4® require higher levels of focused visual concentration than UNO®. In addition, Jenga® and Connect 4® are less complex to understand and require less intellectual involvement than UNO® although Connect 4® requires assessment of visual data and data analysis. Mancala® and Jenga® are considered the least complex and least threatening of the games. They are used for variety and may be used for younger, more shy children.

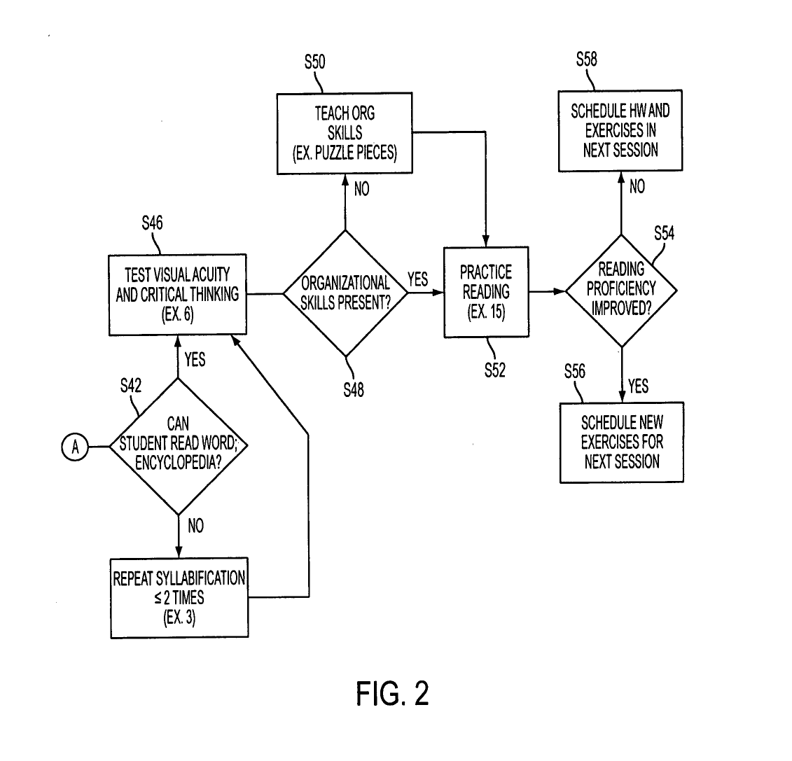

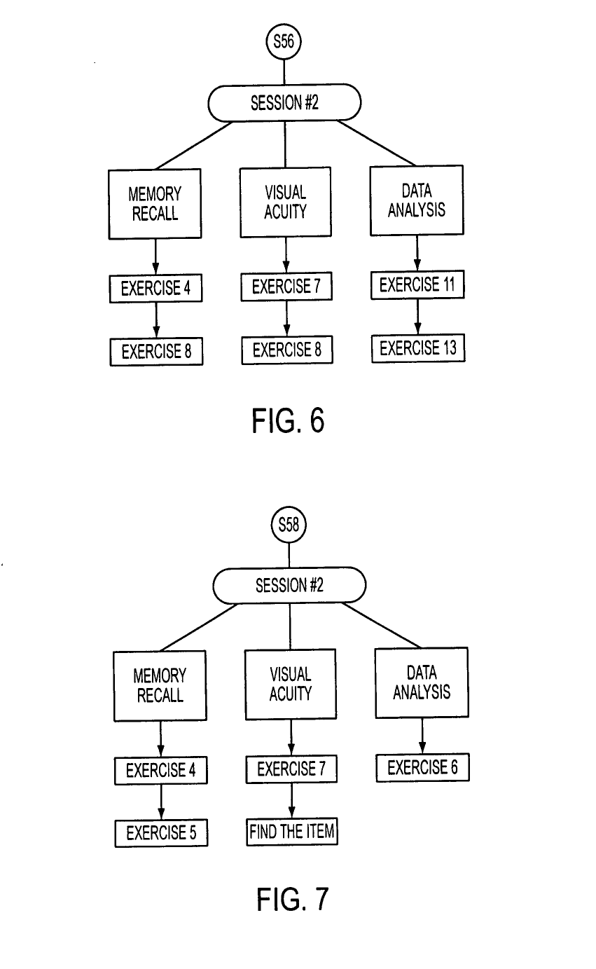

Referring now to the exercises to occur in Session #2 noted in Step 56 in FIG. 2, the types of exercises in keeping with one embodiment of the present invention fall into three skills category: visual acuity, memory recall, and data analysis as depicted in FIG. 6.

More specifically, with respect to visual acuity, Exercises 7 and 8 from FIG. 4 are recommended. Exercise 7 involves placing six to twelve differing types of beads each into individual pockets of an empty 1-dozen egg carton, for example. The grouped beads are used to represent words containing from six to twelve alphabets. Preferably, use beads of different colors, patterns, shapes and sizes, which may represent different vowels and consonants in any given word.

Provide the student with a separate empty 1-dozen egg carton accompanied with containers holding many beads including exact duplicates of the same type of beads earlier presented to the student. Ask the student to now match exactly the colors, patterns, sizes, shapes and placement of the beads in the first egg carton. Observe the amount of time it takes the student to complete the exercise. If the student's bead-matching speed appears slower than optimum, repeat the exercise again. This exercise may also be repeated during subsequent reading lessons.

The objects of Exercise 7 is to give the student visual and tactile stimulation in order to strengthen visual acuity; to give a student practical experience in visualizing a separation between the letters in words; and to give the student an opportunity to sharpen his/her focus through utilization of minute detail work. This exercise also provides information regarding the student's level of attention to detail.

On the other hand, Exercise 8 is designed to provide memorization and spelling practice. It requires a supply of magnetic alphabets, at least three of each letter. Here, the student is provided with a list of vocabulary words that rhyme, which may be retrieved from a rhyming dictionary. The list may contain up to 20 words; the length is gauged according to the student's age and spelling abilities. For example, a six year old may be able to memorize a list of ten words whereas an eight year old may be able to memorize between 15 and 20 words.

Once the number of words in the list is decided upon before beginning the exercise, the student is asked to review the list to determine the existence of any unfamiliar words. Any unfamiliar words are pronounced for the student. Ask the student how much time will be needed to memorize the list of words, and allot the designated time. The instructor is advised to study and memorize the list of words also.

At the end of the allotted study time, the list is removed from view, and the student and instructor take turns recalling one word from the list at a time. The first person to begin will recall one word from the list, select the appropriate alphabets from the pile, and correctly spell the word by laying out the alphabets in order on the playing surface.

Continue alternating turns recalling words until all the words on the list have been recalled. The person who fails to recall a word loses a turn. Play alternates as long as words can be recalled. The exercise is complete when the entire list of words has been recalled and spelled correctly, or when no more words can be recalled. If less than the full list of words has been recalled, review the list to determine the missing words not recalled.

This exercise provides the student with an opportunity to work with groups of words that rhyme but which are composed of differing combinations of vowels and consonants. Exercise 8 provides the student with an opportunity to understand the phenomenon of the spelling irregularities that are common in the English language.

Regarding the skills category of memory recall, the type of exercises in keeping with one embodiment of the present invention is exemplified through application of Exercises 4 and 8. Exercise 8 has been described above.

As to Exercise 4, the goal here is to improve the student's ability to concentrate, improve student memory, and improve the student's understanding of the concept of individual position as contrasted to a group of objects, preferably through the use of concentration card games.

In a preferred embodiment, the cards from a game, such as Old Maid, are used. Under the rules of this game, the deck is shuffled after discarding the Old Maid card. Place the group of cards face down, creating as many rows as needed to place about seven to eight cards in each row.

The object of the game is to turn up one set of two matching cards at a time. Ask the student to turn over any two cards in an attempt to select a matching pair. If the two cards match (i.e. 2 sevens, 2 queens, etc.), the student keeps the pair and gets another turn. However, if the student turns over two cards that do not match, both non-matching cards are then turned back over to their original face-down position, and the student loses a turn.

The key to winning is to remember the face of the cards not matched and to remember the location of the unmatched cards so that at the next turn, new cards overturned may be matched to previously selected overturned cards. Play continues until all the cards have been selected and paired. The winner is the person who has collected the most pairs.

If a student's memory proves somewhat deficient the first time the game is played, this game should be repeated at least two more times during the learning session to provide memory recall practice.

Regarding the skill category of data analysis, the type of exercises in keeping with one embodiment of the present invention is exemplified through application of Exercises 11 and 13.

Practice Exercise 11 is designed to introduce the student to new words to expand vocabulary. The number of new words introduced at each reading session is adjusted based on the student's age and capabilities. For example, a child of age seven or eight may be able to process a vocabulary list of 20 to 60 words. Preferably, a vocabulary list is presented to a student already divided into syllables, and typed in a table or columnar format as depicted in FIG. 5.

In addition, heavy emphasis is placed on new vocabulary of three to six syllables that the student has opportunities to use as well as vocabulary the student is likely to have heard before. These may include words such as cheeseburger, hippopotamus, responsibility, perspiration, mayonnaise, electricity, immediately, handkerchief, tomorrow, telephone, packages, emergency, interruption, and the like. Additional examples are provided in FIG. 5.

To begin Exercise 11, ask the student to review the list of words presented, and identify any known word(s) on the list. Substitute new words for the words the student already knows. All other words on the list should be clearly enunciated for the student. Then have the student read the list of words aloud at least twice. Ask the student to study the list of words between sessions.

Preferably, students are introduced to new vocabulary at least every third to fourth reading session.

Introducing the student to a dictionary's use guide in conjunction with administering Exercise 11 has proved to enhance the student's process of learning of new vocabulary. The guide on how to use a dictionary is generally provided at the front of each dictionary, which every student learning to read should have or have access to.

Two of the most important features of the dictionary for students are the pronunciation and syllabification features. The guide's pronunciation key is designed to aid with questions of vocabulary pronunciation. Thus, the pronunciation feature shows options for how each consonant and vowel in a word may be pronounced. The syllabification feature shows pronunciations divided into syllables within parentheses. These two features combined provide a student a head start in learning new vocabulary quickly and correctly.

In addition, a dictionary and its guide are important to a student's overall understanding of how words are pronounced versus how they are spelled, for several reasons. First, a guide to using a dictionary provides information about a word's history and country of origin, if known. This information provides insight into pronunciation and spelling irregularities in the English language. Second, the dictionary also provides information on what part of speech a word performs in a sentence. This is helpful to improving a student's reading comprehension skills.

Regarding Exercise 13, the goal here is to provide the student with hands-on practice with spelling. Before the reading session, select several words for use for spelling practice. The words selected are preferably words already introduced to the student from a vocabulary list and which may have posed some difficulty for the student.

Select the magnetic alphabets comprising the word to be spelled and place them in random order into a sandwich bag or other such item. Instruct the student to empty the letters onto a work surface and arrange the letters into a known word.

If the student is unable to organize the letters into a word within five minutes, offer the student a clue to the identity of the word. If needed, the student may be told which column of the vocabulary list the word may be found. This provides the student with an opportunity to review the word list and compare the magnetic letters against it. This exercise provides the student with an opportunity to practice and sharpen visual acuity and spelling skills.

Referring back to the exercises to occur in Session #2 noted in Step 58 (S58), the types of exercises in keeping with one embodiment of the present invention also fall into the same three skills category: visual acuity, memory recall and data analysis. However, some of the exercises are different to those described with reference to Step 56, as depicted in FIG. 7.

For example, with respect to visual acuity, Exercises 7 and Find-the-Item are recommended for the student. Exercise 7 was previously described. Find the Item Exercise is an inexpensive booklet for purchase that contains pages of simple to complex picture drawings with hidden drawings of listed items contained within the drawings. One booklet provides a list of up to 40 or more items that are hidden in each drawing. Other booklets provide simpler, less complex drawings with fewer items hidden in the drawing. This exercise is excellent for practice in visual discrimination for adult and younger students.

Regarding the skills category of memory recall, the type of exercises in keeping with the present invention is exemplified through application of Exercises 4 and 5. Exercise 4 was described above.

As to Exercise 5, which is the electronic concentration game called SIMON™, the object of the game is to see how fast and how many of a sequence of color light signals emitted by the game unit a player can repeat without making an error. The game allows a player only five seconds to press one of four large buttons. The longest possible sequence of lighted signals is 31 seconds. When a player makes an error in repeating a sequence, or takes too long to respond by depressing the correct button, the game unit sounds a loud buzzing noise that signals the end of the round.

Using SIMON™ provides practice for strengthening memory recall, which aids a student in remembering spelling and newly learned words, as well as supporting reading comprehension by assisting students to recall topics and activities read.

Regarding the skills category of data analysis, the types of exercises in keeping with one embodiment of the present invention is administered through application of Exercise 6, which was earlier described.

Preferably, before the first reading session, it is advisable that the student is checked for vision or hearing problems, whether they are diagnosed or undiagnosed. The aim is to ensure that any reading deficiency detected is not caused by uncorrected vision, impaired hearing or other treatable health condition, for example.

After it has been determined that no hearing or vision or other health problems exist, students are able to properly begin improving their reading ability by completing the steps provided in the present invention earlier described. These steps were selected in order to assist an instructor to determine where a breakdown has occurred in the student's reading skills set. Each reading lesson averages two to 2 and one-half hours.

Notably, instructor attitude is critical when teaching reading to students. Instructors who bring a playful mood to the reading session are more likely to draw the student into the session. Consequently, the student is more likely to apply his/her attention to improving his/her reading skills. Providing reassurances that lack of success in reading is not attributable to the student's intelligence level or effort but may be attributable to outside factors (i.e. illness, emotional trauma, etc.), also aids student confidence and consequently improved student effort and likely success.

Game-playing when used as a reading teaching tool supplants the dread and opposition some students have developed toward the learning process due to their negative past learning experiences. The game playing aspect of this learning process is used to stimulate the student's enjoyment in learning to read, and is designed to bring intellectual inquisitiveness and contemplation to the learning process.

The inventor has found that once both intellectual energy and desire to participate in the learning process have been stimulated, an instructor's use of the proprietary compilation of exercises with a student strengthens the four primary skills important to the reading process: critical thinking, visual acuity or discrimination, memorization and recall, and data analysis. Employing the present invention to teach students to read or to improve their reading skills, increased students' proficiency in these four skills areas to where students recognize familiar words, comprehend definitions, read passages more quickly and fluently, and recalled the information conveyed through the text the students read.

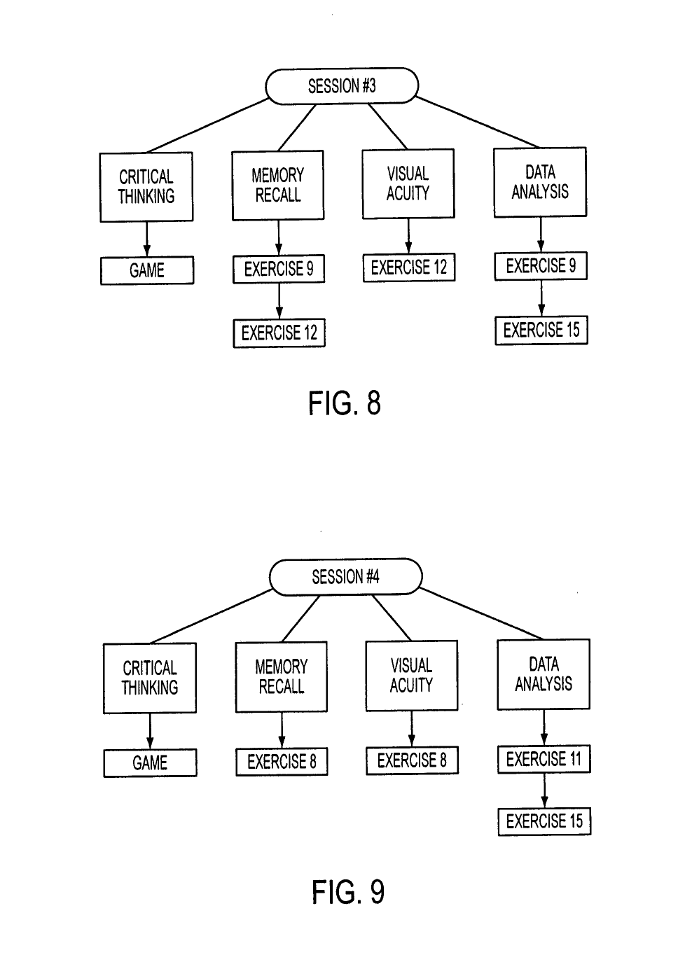

By way of additional exercises for subsequent reading lessons with a student, reference is had to FIG. 8, which depicts recommended exercises for a third session with the student. For efficiency, a discussion of a previously described exercise is not repeated but may be referred to in earlier portions of this specification.

For critical thinking exercise, the student may select a game of choice unless the instructor desires to enhance a specific skill during the session. Game play should approximate 15 to 20 minutes.

If homework was assigned, review the homework to assess the student's progress and understanding of the material, to discuss accomplishments, and any areas requiring further reinforcement. Preferably, this portion of the session should last 10 to 20 minutes.

Regarding the skills category of memory recall, the types of exercises in keeping with one embodiment of the present invention is administered through application of Exercise 9.

Exercise 9 involves memorizing poetry. Students may benefit from reading, memorizing and reciting full-length poetry prescribed by the instructor, or other poems of the student's choice. The student may begin with poetry that rhymes as it may be easier to recall, and then move on to non-rhyming poetry, if preferred. Also, this poetry memorization and recall exercise may be less intimidating for the student when the reading instructor participates in the reading and memorization of poems. The student and instructor may select one poem and alternate reading lines or stanzas.

Alternatively and/or optionally, the student and instructor may alternate turns reading complete poems. Alternating turns is very beneficial as it provides the student an opportunity to listen to the vocal cadence and pronunciation of a more experienced reader. This benefit is of highest value to those students who read with long pauses between each word.

The student may begin with a poem approximating the amount of text that correlates to a page of text in a conventional children's book, such as four stanzas or a minimum of eight lines. The instructor may show the student how to develop a system for memorizing a poem by pointing out different elements in each line of a poem. For example, if the poem is about animals, encourage the student to discuss the order in which the animals are mentioned.

Along with a general goal of supporting training and practice for the memorization skill, this exercise may be used to show the student how easy it is to memorize and recall a block of textual information quickly. This exercise may also be used to support a student's reading comprehension abilities because the student is required to review and repeat the material several times in order to ensure all the information is assimilated and completely memorized. Preferably, the instructor assists the student with pronunciation and definitions of new vocabulary. In addition, use of a dictionary during reading sessions facilitates defining newly-learned vocabulary.

The second recommended exercise for memory recall is Exercise 12, which is excellent for: building new vocabulary; providing practice for reinforcing the student's memory; helps the students to understand the divisibility of words into syllables; and assists the student with learning to spell new vocabulary.

To begin Exercise 12, ask the student to review the list of words created, and identify any known word(s) on the list. Substitute new words for the words the student already knows. All other words on the list should be clearly enunciated for the student. Then have the student read the list of words aloud at least twice. Ask the student to study the list of words between sessions.

At a session subsequent to introducing Exercise 11, as a follow-up, two or three copies of the word list are cut into individual slips of one word each and placed into a bowl or container. After selecting one word/slip of paper at a time from the container, the student reads the word. If the student recognizes the word, it is placed in one pile. If the student does not recognize the word, it is enunciated for the student and placed in another separate pile. In other words, two piles for the word slips are created; one pile for words the student recognizes, and another pile for words the student does not recognize.

Selection of each word continues until all the slips of papers are removed from the container and read by the student. Any word in the pile of words that the student was unable to read is returned to the container. The student repeats the process, drawing slips from the container and placing the slips of paper into either pile based on whether the word is recognized or not. The point is for the student to select these words from the container until the student recognizes the word(s) on sight.

Alternatively and/or optionally, rather than placing unrecognized words in a separate pile, the student may return those word slips directly back into the container. In this fashion, the student continues to pull and read word slips, returning the unrecognized words back to the container, and selecting them until the student recognizes all the words.

The instructor's role is to record a list of words that presented difficulty for the student, who is instructed to review these words between reading lessons. At the next session, for example, the instructor may test the student's memory of the words with a short spelling quiz before beginning a new list of words.

Referring to FIG. 8, it is shown that Exercise 12 is also useful as a visual acuity exercise. In addition, it is shown that Exercise 9, which was previously described, is an appropriate exercise for data analysis.

The second recommended exercise for data analysis is Exercise 15, which was previously described.

Referring now to FIG. 9, there is shown a sample lesson plan for Session #4, which preferably occurs approximately 4 weeks after the first session. As depicted, the recommended lesson plan for critical thinking skills is to play a game as earlier described. The recommended lesson plan to address memory recall and visual acuity skills is Exercise 8, which has been described. Unlike the lesson plan in Session #3 for data analysis, the recommended lesson plan includes Exercises 11 and 15, which have been described.

Regarding homework assignments, one recommended assignment for the student after Session #3 includes Exercise 10, which involves writing a poem. The goal of this exercise is to provide the student practical experience with the intellectual manipulation of words, which in turn leads to improved reading comprehension. It offers the student an opportunity to practice what is being learned during reading lessons by creating his or her own material. This exercise may also help to remove or reduce any intimidation some students experience while learning to interpret written language.

Another recommended homework assignment includes at least one search/word find assignment. This is accomplished through word search and word find booklets, which introduce new vocabulary and provide opportunities to practice spelling new vocabulary. The booklets contain a list of vocabulary words along with a grid containing several rows of letters. The words in a list may be found in the grid of letters reading forward, backward, and diagonally from top to bottom and from bottom to top. These booklets are excellent for young and adult students because they generally provide vocabulary on common interesting topics such as television shows, food, events, sports, hobbies, geography and other varied interest areas.

Other recommended assignments may include a word jumble exercise, putting together a 3-D puzzle and mazes.

Another practical experience lesson (Exercise 17) is writing short stories. As part of a student's reading training, a student is encouraged to write short stories or commentaries of one page or less in order to use and reinforce the new skills they are learning. Handwriting or typing short stories provides students with opportunities to internalize their newly learned skills and de-mystify the reading experience.

Preferably have the student read the short story or commentary aloud. Highlight and correct incorrectly spelled words either on a separate list for the student or on the essay for the student's easy future reference. Writing short stories or commentaries is encouraged to become a regular part of the student's reading instructional session.

One recommended assignment for the student after Session #4 includes Exercise 17, a word jumble exercise, mazes; 3-D puzzle, and at least one word search/word find exercise on a topic appropriate to the student's age/interest.

The many features and advantages of this invention are apparent from the detailed specification. The above description and drawings are only illustrative of preferred embodiments that achieve the features and advantages of the present invention, and it is not intended that the present invention be limited thereto. Thus, it is intended by the appended claims to cover all such features and advantages of the invention that fall within the true spirit and scope of the invention.

Further, since numerous modifications and variations will readily occur to those skilled in the art, it is not desired to limit the invention to the exact construction illustrated and described. Accordingly, all suitable modifications and equivalents of the present invention that come within the spirit and scope of the following claims are considered to be part of the present invention.

What is claimed is:

1. A method for improving reading, comprising the steps of:
(a) employing a game useful for teaching reading skills;
(b) identifying one or more reading deficiencies;
(c) testing one or more reading skills in the areas of memory, visual acuity, data analysis and critical thinking; and
(d) administering one or more exercises in said areas.

2. The method according to claim 1, further comprising a step of employing a game of fun.

3. The method according to claim 1, further comprising a step of employing a game transferable to a learning process.

4. A method for teaching reading, comprising the steps of:
(a) employing a game of fun;
(b) identifying one or more reading deficiencies;
(c) testing one or more reading skills in the areas of memory, visual acuity, data analysis and critical thinking; and
(d) administering one or more exercises in said areas.

5. Method and materials for teaching reading, comprising the steps of:
(a) employing a game useful for teaching one or more elements of reading;
(b) identifying one or more difficulties to reading;
(c) testing one or more reading skills in the areas of memory, visual acuity, data analysis and critical thinking, using at least one game; and
(d) administering one or more type of exercises in said areas, said type of exercises including one of critical thinking and memorization.
